(19) United States
(12) Patent Application Publication
(10) Pub. No.: US 2023/0134065 A1
(43) Pub. Date: May 4, 2023

(54) INFORMATION PROCESSING SYSTEM, SERVICE PROVIDING SYSTEM, AND APPLICATION EXECUTION METHOD

(71) Applicant: Yohsuke Someya, Kanagawa (JP)

(72) Inventor: Yohsuke Someya, Kanagawa (JP)

(73) Assignee: Ricoh Company, Ltd., Tokyo (JP)

(21) Appl. No.: 17/936,918

(22) Filed: Sep. 30, 2022

(30) Foreign Application Priority Data
Oct. 28, 2021 (JP) 2021-176843

(51) Int. Cl. H04N 1/00

(52) U.S. Cl. CPC H04N 1/00474; H04N 1/00442; H04N 2201/3288

(57) ABSTRACT

An information processing system, a service providing system, and an application execution method. The information processing system receives a request to create an application that includes one or more processes, generates a workflow in which a process of storing data in a storage area is added to a process of acquiring the data from outside based on the one or more processes included in the application, executes the application and the workflow in response to receiving a request for executing the application from a device, and provides the device with screen information for displaying information on the data stored in the storage area.

### CROSS-REFERENCE TO RELATED APPLICATIONS

This patent application is based on and claims priority pursuant to 35 U.S.C. § 119(a) to Japanese Patent Application No. 2021-176843, filed on Oct. 28, 2021, in the Japan Patent Office, the entire disclosure of which is hereby incorporated by reference herein.

### BACKGROUND

### Technical Field

The present disclosure relates to an information processing system, a service providing system, and an application execution method.

### Related Art

Services that provide applications combining multiple functions (for example, scanning, saving to a folder, sending e-mail, etc.) are known. A process performed by such a service is called a workflow. Some workflows use files, such as printing files stored in an external service system such as a storage server using a device such as an image forming apparatus.

### SUMMARY

Embodiments of the present disclosure describe an information processing system, a service providing system, and an application execution method. The information processing system receives a request to create an application that includes one or more processes, generates a workflow in which a process of storing data in a storage area is added to a process of acquiring the data from outside based on the one or more processes included in the application, executes the application and the workflow in response to receiving a request for executing the application from a device, and provides the device with screen information for displaying information on the data stored in the storage area.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIGS. 1A and 1B are diagrams illustrating relationship between components and applications;

FIG. 2 is a block diagram illustrating a system configuration of an example of a service providing system, according to an embodiment of the present disclosure;

FIG. 3 is a block diagram illustrating a hardware configuration of an example of an information processing system and a terminal;

FIG. 4 is a block diagram illustrating a hardware configuration of an image forming apparatus as an example of a device;

FIG. 5 is a block diagram illustrating a functional configuration of an example of a service providing system;

FIG. 6 is a block diagram illustrating whether a temporary file area is directly accessible from each functional unit in the functional block diagram of FIG. 5;

FIGS. 7A, 7B, and 7C are schematic diagrams illustrating an automatic workflow generation process executed by a workflow generation unit;

FIG. 8 is a diagram illustrating an example of an application creation screen;

FIG. 9 is a sequence diagram illustrating an example of the automatic workflow generation process executed by the information processing system according to a first embodiment of the present disclosure;

FIG. 10 is a sequence diagram illustrating an example of a display process of a preview of a file executed by an application including an internal component according to the first embodiment of the present disclosure;

FIG. 11 is a sequence diagram illustrating an example of a display process of a preview of a file executed by an application including an external component according to the first embodiment of the present disclosure;

FIG. 12 is a sequence diagram illustrating an example of the automatic workflow generation process executed by the information processing system according to a second embodiment of the present disclosure;

FIG. 13 is a sequence diagram illustrating an example of a preview file display process executed by an application for which an automatically generated workflow is generated according to the second embodiment of the present disclosure;

FIG. 14 is a sequence diagram illustrating an example of the automatic workflow generation process executed by the information processing system according to a third embodiment of the present disclosure;

FIG. 15 is a diagram illustrating an example of a file browse screen displayed by the device; and

FIG. 16 is a diagram illustrating a display example of a preview image of a file selected by file browse.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, an information processing system and an application execution method executed by the information processing system are described with reference to the drawings as an embodiment of the present disclosure.

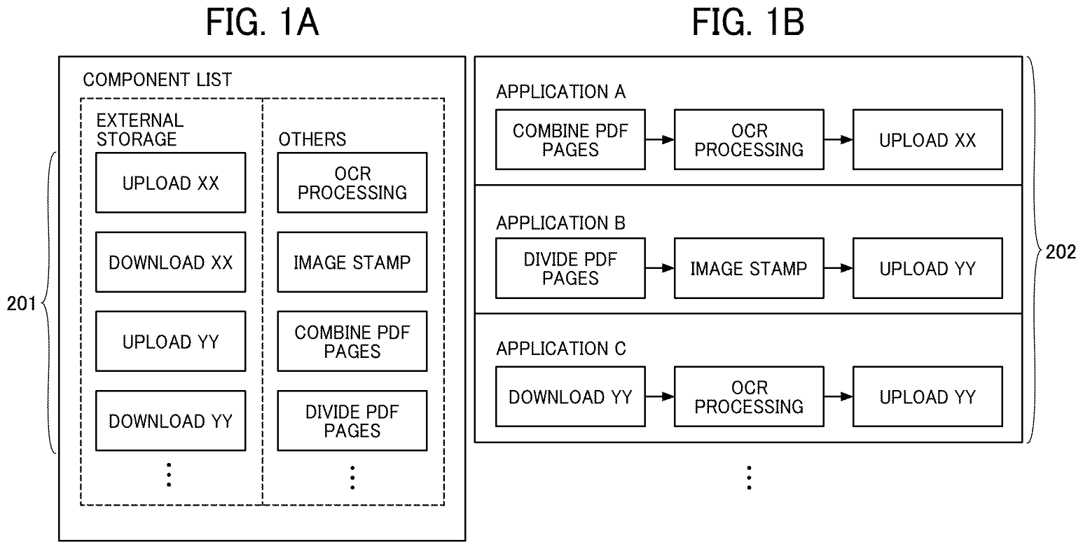

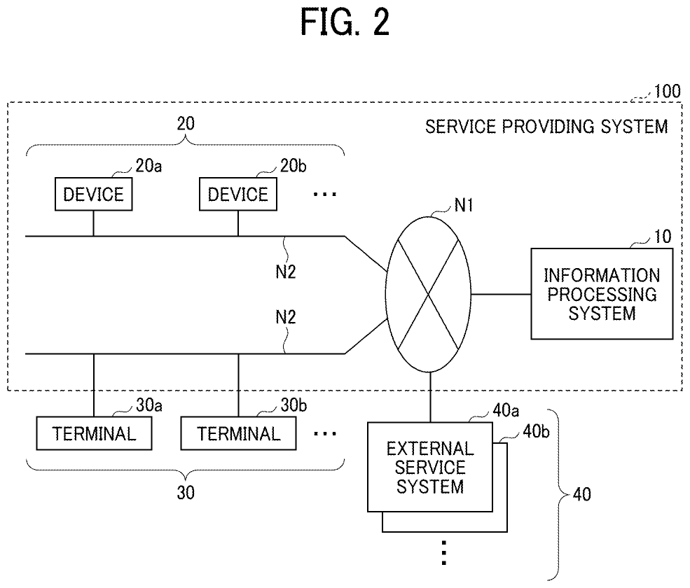

With reference to FIGS. 1A and 1B, description is given of a workflow. FIGS. 1A and 1B are diagrams illustrating relationship between components 201 and applications 202. In the present embodiment, an application 202 is created by combining multiple components 201. A component 201 is a part of a program prepared for each function or processing unit. As illustrated in FIG. 1A, components 201 for uploading and downloading files to various external service systems, and processing optical character recognition (OCR), stamps, and portable document format (PDF) on files are prepared.

As illustrated in FIG. 1B, the applications 202 are created by arranging one or more components 201 in order of execution. The workflow is executed by executing the application 202.

The components 201 include two types of components, an “internal component” and an “external component”. The internal component (an example of a first type of processing) includes functions available to the component. The internal component is developed internally for the information processing system. The external component (an example of a second type of processing) is limited in functions available to the components. The external component is developed by an application developer other than the developer of the information processing system (such products are sometimes called third-party products).

A function of displaying a preview of a file stored by an external service system on the device is implemented by the internal component. In the preview function, the internal component stores a thumbnail image obtained from the external service system in the temporary file area, and issues a universal resource locator (URL) for accessing the temporary file to the device (application). The application displays the preview by embedding the thumbnail image stored in the temporary file area in the user interface without authentication of the external service system.

However, in the case of the external component, the function of storing in the temporary file area managed by the information processing system is restricted, so the thumbnail image is not stored in the temporary file area. For this reason, the preview function is not implemented by the external component. Note that the function of the external component is limited in consideration of security and the like.

In the present embodiment, the internal component that stores thumbnail image in the temporary file area (a temporary file storage component described below) is prepared, and in the case the external component performs file browse and the like, the information processing system automatically generates the automatically generated workflow that incorporates the temporary file storage component. The temporary file storage component is executed when the external component performs preview display by executing the application. By doing so, the information processing system implements the preview function by the external component without removing the restriction that external component does not store the thumbnail image in the temporary file area.

An application is a program executed by the device or the information processing apparatus for a user to receive a service. Applications include a web application that is executed in cooperation with a web browser and a server program, and a native application that is executed by the information processing apparatus without a server but may communicate with the server. In the case of the web application, the application may be a workflow application that executes a series of processes in order.

The application includes one or more processes. The process may be information processing in which a certain number of functions are combined for the application to produce desired output. In the present embodiment, information processing executed by the component, or the component corresponds to the process.

A workflow refers to a plurality of processes or a plurality of processes executed in a predetermined order.

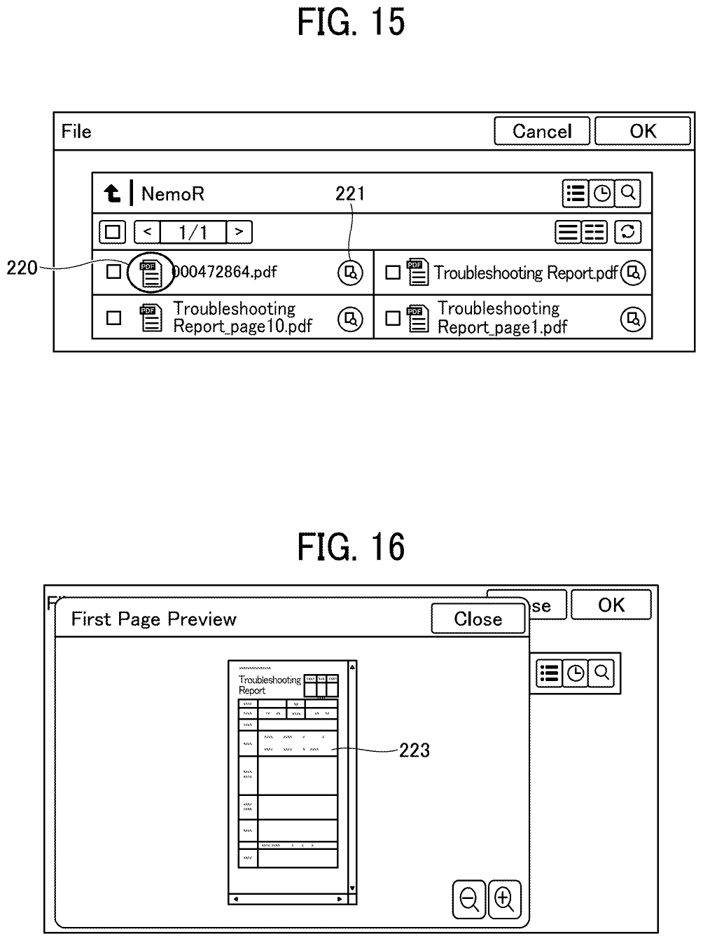

A file browse refers to a file or folder display method that displays a list of files and the structure of folders on a display and accepts selection. FIG. 15 is a diagram illustrating an example of the file browse.

A preview is a simulated image of an output result before actually outputting the result, or displaying the simulated image on a screen. FIG. 16 is a diagram illustrating an example of a preview image.

With reference to FIG. 2, a system configuration of a service providing system 100 according to the present embodiment is described. FIG. 2 is a diagram illustrating the system configuration of an example of the service providing system 100 according to embodiments of the present disclosure.

The service providing system 100 illustrated in FIG. 2 includes an information processing system 10, a device 20, and a terminal 30, which are communicably connected through a wide area network N1 such as the internet. The service providing system 100 communicates with an external service system 40, which is an external system.

The information processing system 10 is implemented by one or more information processing apparatuses, and provides various services implemented by a series of processes in cooperation with the external service system 40 such as a cloud service through the network N1. Specific examples of services provided by the information processing system 10 according to the present embodiment is described below. The information processing system 10 may be implemented by cloud computing or may be implemented by a single information processing apparatus. The cloud computing refers to a usage pattern in which resources on a network are used without being aware of specific hardware resources. The information processing system 10 may reside on the internet or may reside on-premises. The series of processes is provided by one application, and the series of processes is called the workflow.

The devices 20 are various electronic devices used by the users. The device 20 is, for example, an image forming apparatus such as a multi-function peripheral (MFP), a personal computer (PC), a projector, an electronic whiteboard, a teleconference terminal, a digital camera, or the like. The device 20 is connected to a network N2. The user uses the device 20 to use various services provided by the information processing system 10 or the external service system 40.

In addition, the plurality of devices 20 is described using suffixes such as “device 20a” and “device 20b” when distinguishing between the devices 20.

The terminal 30 is, for example, a desktop PC, a notebook PC, a smart phone, a tablet terminal, or the like used by an administrator or a user. The terminal 30 is connected to the network N2. The administrator or the user operates the terminal 30 to use various services provided by the information processing system 10 or the external service system 40, and sets up applications.

In addition, the plurality of terminals 30 is described using suffixes such as “terminal 30a” and “terminal 30b” when distinguishing between the terminals 30.

The external service system 40 is one or more information processing apparatuses that provide services by executing applications through the network N1. Data is saved or read by executing the application. “External” of the external service system 40 indicates a system different from the information processing system 10. The external service systems 40 are often operated by different companies. For example, the external service system 40 and the information processing system 10 have different accounts for one same user.

Examples of the external service system 40 include various cloud services, application service providers (ASPs), and the like, and may include various external services provided through the network. For example, an example of the service includes a storage service. The external service system 40 may reside on the internet or may reside on-premises.

In the following, when distinguishing among the plurality of external service systems 40, the external service systems 40 are referred to as “external service system 40a”, “external service system 40b”, and the like.

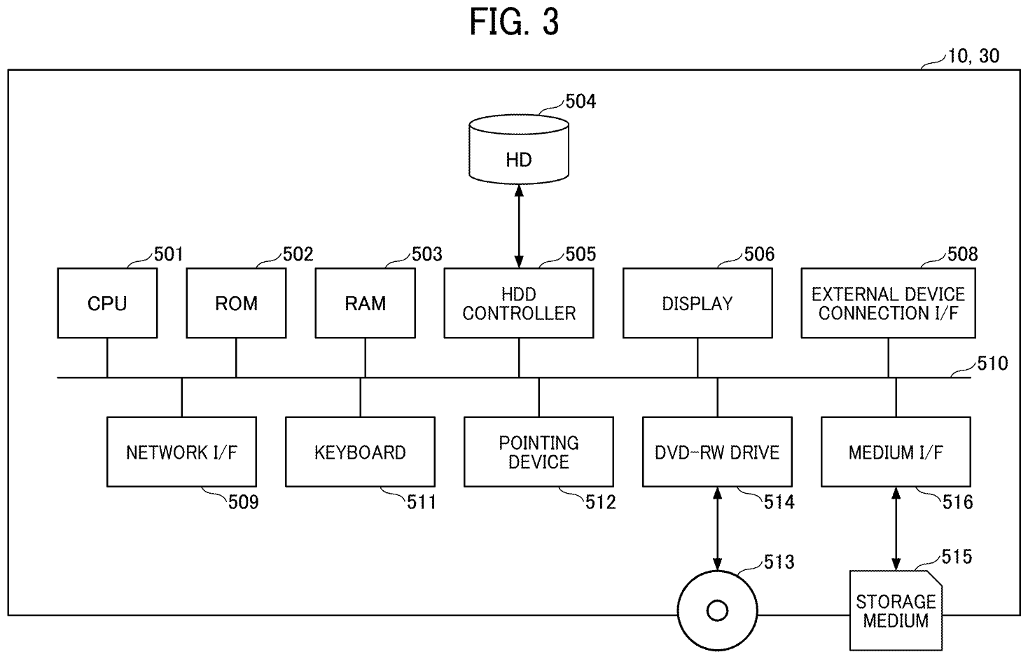

With reference to FIG. 3, a hardware configuration of the information processing system 10 and the terminal 30 according to the present embodiment is described.

FIG. 3 is a block diagram illustrating the hardware configuration of an example of the information processing system 10 and the terminal 30. As illustrated in FIG. 3, the information processing system 10 and the terminal 30 are implemented by a computer including a central processing unit (CPU) 501, a read only memory (ROM) 502, a random access memory (RAM) 503, a hard disk (HD) 504, a hard disk drive (HDD) controller 505, a display 506, an external device connection interface (I/F) 508, a network I/F 509, a bus line 510, a keyboard 511, a pointing device 512, a digital versatile disc-rewritable (DVD-RW) drive 514 and a medium I/F 516.

The CPU 501 controls overall operation of the information processing system 10 and the terminal 30. The ROM 502 stores a control program such as an initial program loader (IPL) to boot the CPU 501. The RAM 503 is used as a work area for the CPU 501. The HD 504 stores various data such as the programs. The HDD controller 505 controls reading and writing of various data from and to the HD 504 under control of the CPU 501. The display 506 displays various information such as a cursor, menu, window, character, or image. The external device connection I/F 508 is an interface for connecting various external devices. The external device in this case is, for example, a Universal Serial Bus (USB) memory or a printer. The network I/F 509 is an interface for performing data communication using the network. The bus line 510 is an address bus, a data bus, or the like for electrically connecting each component such as the CPU 501 illustrated in FIG. 3.

The keyboard 511 is an example of input device including a plurality of keys used for inputting characters, numerical values, various instructions, and the like. The pointing device 512 is another example of the input device that allows a user to select or execute a specific instruction, select a target for processing, or move a cursor being displayed. The DVD-RW drive 514 reads and writes various data from and to a DVD-RW 513, which is an example of a removable storage medium. The removable storage medium is not limited to the DVD-RW and may be a digital versatile disc-recordable (DVD-R) or the like. The medium I/F 516 controls reading and writing (storing) of data from and to a storage medium 515 such as a flash memory.

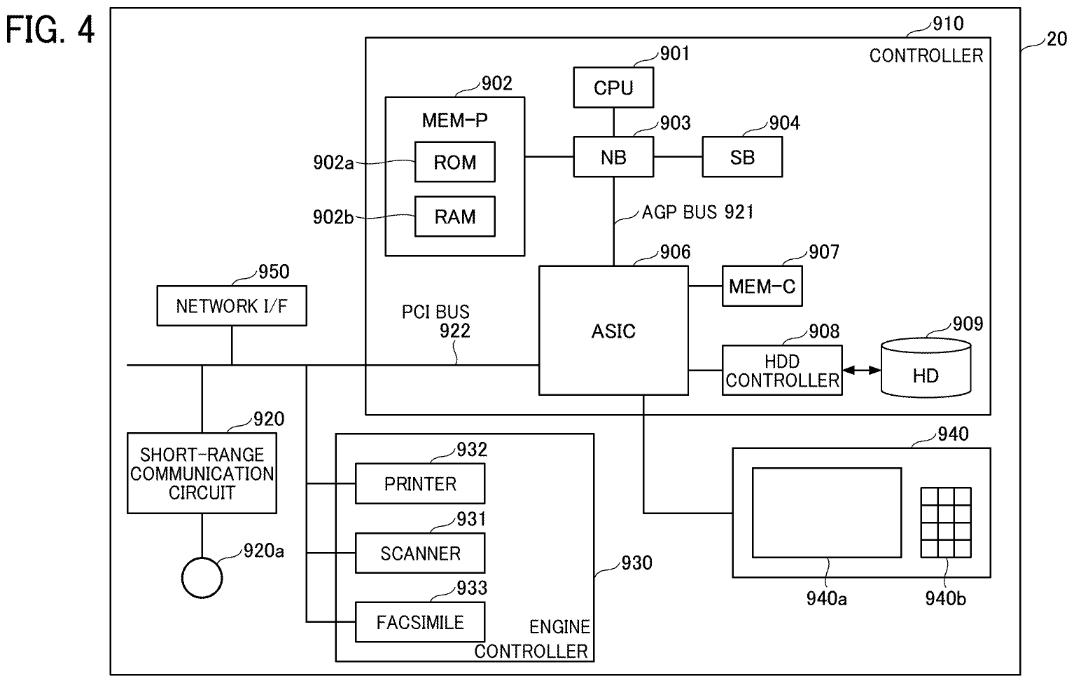

FIG. 4 is a block diagram illustrating a hardware configuration of the image forming apparatus as an example of the device 20. As illustrated in FIG. 4, the image forming apparatus includes a controller 910, a short-range communication circuit 920, an engine controller 930, a control panel 940, and a network I/F 950.

The controller 910 includes a CPU 901 as a main processor, a system memory (MEM-P) 902, a north bridge (NB) 903, a south bridge (SB) 904, an Application Specific Integrated Circuit (ASIC) 906, a local memory (MEM-C) 907, an HDD controller 908, and an HD 909 as a storage unit. The NB 903 and the ASIC 906 are connected through an Accelerated Graphics Port (AGP) bus 921.

The CPU 901 is a processor that performs overall control of the image forming apparatus. The NB 903 connects the CPU 901 with the MEM-P 902, SB 904, and AGP bus 921 and includes a memory controller for controlling reading or writing operation of various data with respect to the MEM-P 902, a Peripheral Component Interconnect (PCI) master, and an AGP target.

The MEM-P 902 includes a ROM 902a as a memory that stores program and data for implementing various functions of the controller 910. The MEM-P 902 further includes a RAM 902b as a memory that deploys the program and data, or as a drawing memory that stores drawing data for printing. The program stored in the ROM 902a may be stored in any computer-readable storage medium, such as a compact disc-read only memory (CD-ROM), compact disc-recordable (CD-R), or digital versatile disc (DVD), in a file format installable or executable by the computer for distribution.

The SB 904 is a bridge for connecting the NB 903 with a peripheral component interconnect (PCI) device or a peripheral device. The ASIC 906 is an integrated circuit (IC) dedicated to an image processing use, and connects the AGP bus 921, a PCI bus 922, the HDD controller 908, and the MEM-C 907 as a bridge. The ASIC 906 is a PCI target and an AGP master, an arbiter (ARB) which is the core of the ASIC 906, a memory controller which controls MEM-C 907, a plurality of Direct Memory Access Controllers (DMACs) which rotate image data by hardware logic and the like, and a PCI unit that transfers data between a scanner 931, a printer 932, and a facsimile 933 through the PCI bus 922. The ASIC 906 may include a USB interface and an Institute of Electrical and Electronics Engineers 1394 (IEEE1394) interface.

The MEM-C 907 is a local memory used as a buffer for image data to be copied or a code buffer. The HD 909 is a storage that stores image data, font data used during printing, and forms. The HDD controller 908 reads or writes various data from or to the HD 909 under control of the CPU 901. The AGP bus 921 is a bus interface for a graphics accelerator card, which has been proposed to accelerate graphics processing. Through directly accessing the MEM-P 902 by high-throughput, speed of the graphics accelerator card is improved.

The short-range communication circuit 920 includes a short-range communication antenna 920a. The short-range communication circuit 920 is a communication circuit that communicates in compliance with Near Field Communication (NFC), BLUETOOTH (registered trademark) and the like.

The engine controller 930 includes the scanner 931, the printer 932, and the facsimile 933. The control panel 940 includes a display panel 940a implemented by, for example, a touch panel that displays current settings or a selection screen and receives a user input and an operation panel 940b including a numeric keypad that receives set values of various image forming parameters such as image density parameter and a start key that accepts an instruction for starting copying. The controller 910 controls entire operation of the image forming apparatus. For example, the controller 910 controls rendering, communication, or user input to the control panel 940. The scanner 931 or the printer 932 includes an image processing unit such as error diffusion processing and gamma conversion processing.

Note that the image forming apparatus switches and selects a document box function, copy function, print function, and facsimile function in sequence using an application switching key on the control panel 940. In response to a selection of the document box function, the device 20 switches to document box mode, in response to a selection of the copy function, the device 20 switches to copy mode, in response to a selection of the print function, the device 20 switches to print mode, and in response to a selection of the facsimile function, the device 20 switches to facsimile mode.

The network I/F 950 is an interface for performing data communication using the network N2. The short-range communication circuit 920 and the network I/F 950 are electrically connected to the ASIC 906 through the PCI bus 922.

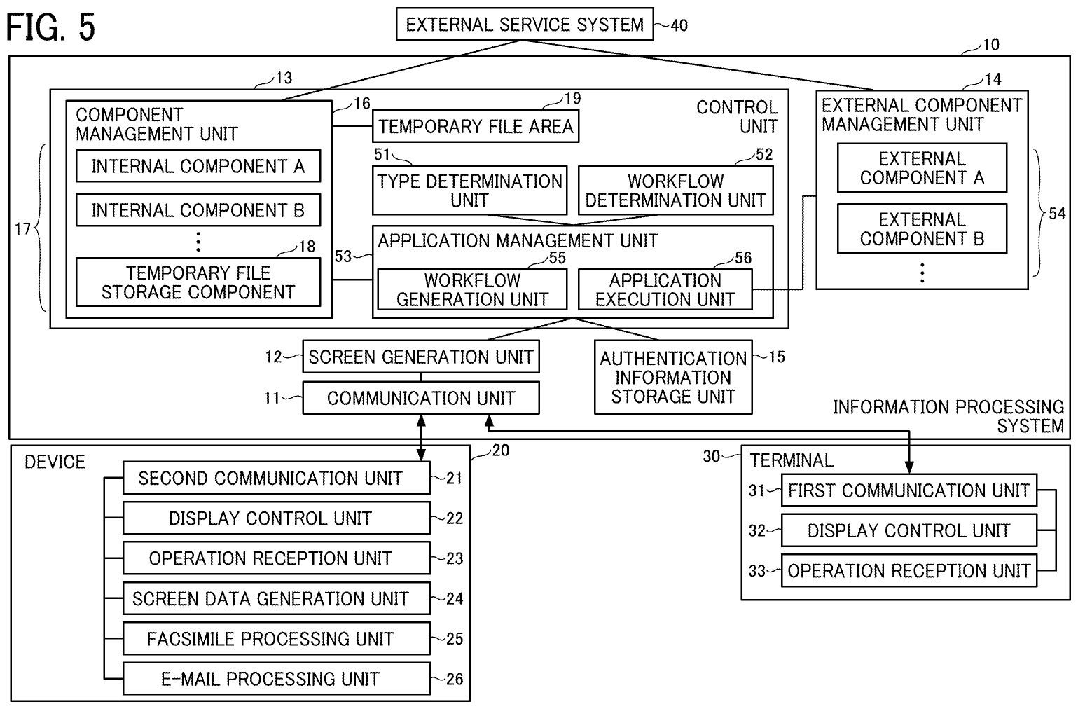

With reference to FIG. 5, a functional configuration of the service providing system 100 according to the present embodiment is described. FIG. 5 is a block diagram illustrating the functional configuration of an example of the service providing system 100.

The device 20 includes a second communication unit 21, a display control unit 22, an operation reception unit 23, a screen data generation unit 24, a facsimile processing unit 25, and an e-mail processing unit 26. Each of these functional units is a function implemented by the CPU 901 illustrated in FIG. 4 executing instructions included in one or more programs installed in the device 20. For example, the second communication unit 21, the display control unit 22, and the operation reception unit 23 are implemented by a web browser, and the other functional units are implemented by individual applications (native applications).

The second communication unit 21 transmits and receives various information to and from the information processing system 10. In the present embodiment, the second communication unit 21 receives screen information and the like of an application list screen from the information processing system 10 and transmits an application execution request and the like to the information processing system 10.

The display control unit 22 interprets the screen information of various screens and displays the screens on the display panel 940a. The operation reception unit 23 receives operation of the user on various screens displayed on the display panel 940a.

In response to the operation reception unit 23 receiving a selection of an application that generates image data, a document is scanned by the scanner 931 and the screen data generation unit 24 generates image data. The facsimile processing unit 25 performs processing related to facsimile reception and transmission by the facsimile 933. In response to receiving a facsimile, the information processing system 10 is requested to execute an application associated in advance. Note that the facsimile processing unit 25 may request an application corresponding to the facsimile transmission source (facsimile number).

The e-mail processing unit 26 performs processing related to e-mail transmission and reception. In response to receiving an e-mail, the information processing system 10 is requested to execute an application associated in advance. Note that the e-mail processing unit 26 may request an application corresponding to the source of the e-mail (e-mail address).

The terminal 30 includes a first communication unit 31, a display control unit 32 and an operation reception unit 33.

Each of these functional units is implemented by the CPU 501 executing an instruction included in one or more programs installed in the terminal 30. The program may be a web browser or dedicated software.

The first communication unit 31 transmits and receives various information to and from the information processing system 10 or the external service system 40. In the present embodiment, screen information and the like related to creation of an application are received from the information processing system 10 and application information set by an application administrator is transmitted to the information processing system 10.

The display control unit 32 interprets the screen information of various screens and displays screens on the display 506.

The operation reception unit 33 receives various operations of the application developer on various screens displayed on the display 506.

The information processing system 10 includes a communication unit 11, a screen generation unit 12, a control unit 13, an external component management unit 14, and an authentication information storage unit 15. Each of these functional units is a function implemented by the CPU 501 illustrated in FIG. 3 executing instructions included in one or more programs installed in the information processing system 10. Also, the authentication information storage unit 15 is implemented in the HD 504 or the like illustrated in FIG. 3.

The communication unit 11 transmits and receives various information between the terminal 30 and the device 20. In the present embodiment, the communication unit 11 receives an application creation request from the terminal 30. Further, the communication unit 11 transmits an application list to the device 20 or the terminal 30 for executing an application, and receives an application execution request.

The screen generation unit 12 generates screen information to be displayed by the terminal 30 for creating the application, and generates screen information for a screen to be displayed by the device 20 for executing the application. The screen information is a program described in HyperText Markup Language (HTML), Extensible Markup Language (XML), a script language, and Cascading Style Sheet (CSS). The structure of the web page is mainly defined by HTML, the operation of the web page is defined by the script language, and the style of the web page is defined by CSS.

The authentication information storage unit 15 stores user authentication information in the external service system 40. The authentication information of the external service system 40 is associated with the user ID (user identification information) and the like in the information processing system 10. The authentication information is known information such as user ID and password, IC card number, and biometric authentication information. In the case single sign-on such as OAUTH is possible, the authentication information storage unit 15 may be omitted.

The control unit 13 is described in the following. The control unit 13 includes a component management unit 16, a temporary file area 19, a type determination unit 51, a workflow determination unit 52, and an application management unit 53.

The component management unit 16 manages entities of internal components 17 (including a temporary file storage component 18). In response to a calling of the internal component 17 from the application management unit 53, the component management unit 16 calls and executes the internal component 17. The temporary file storage component 18 is incorporated into the automatically generated workflow when creating the application in which the external component displays the preview by file browse. The temporary file storage component 18 is the internal component and has access to the temporary file area 19.

The application management unit 53 manages a configuration of application (such as execution order of components), correspondence between the application and automatically generated workflow, and the like. The application management unit 53 includes a workflow generation unit 55 and an application execution unit 56. The workflow generation unit 55 generates and manages the automatically generated workflow according to the application based on determination results of the workflow determination unit 52 and the type determination unit 51. To execute the application, the application execution unit 56 calls the application and the components included in the automatically generated workflow associated with the application.

The workflow determination unit 52 determines whether to generate the automatically generated workflow based on the configuration of application. Criteria for determination include whether a specific component is included, or whether a component having a parameter that designates a specific input format is included. For example, the automatically generated workflow is generated for a component related to the file browse. Based on a determination to generate the automatically generated workflow, the workflow determination unit 52 returns component identification information indicating which component the automatically generated workflow is to be generated for.

The type determination unit 51 determines whether the component is the internal component or the external component based on the identification information of the component.

The temporary file area 19 is a storage area that stores saved files for a certain period of time. The files are automatically deleted after the certain period of time. After obtaining the file, the information processing system 10 may delete the temporary file area 19. The temporary file area 19 may be implemented in the RAM 503, the HD 504, or the like. The temporary file area 19 may be outside the information processing system 10 as long as the temporary file area 19 is managed by the information processing system 10. The internal component 17 issue a URL of the file stored in the temporary file area 19. The information processing system 10 accesses this URL without authentication information of the external service system 40.

The external component management unit 14 manages the entity of the external component 54. In response to receiving a call from the application management unit 53, the external component management unit 14 calls and executes the external component 54.

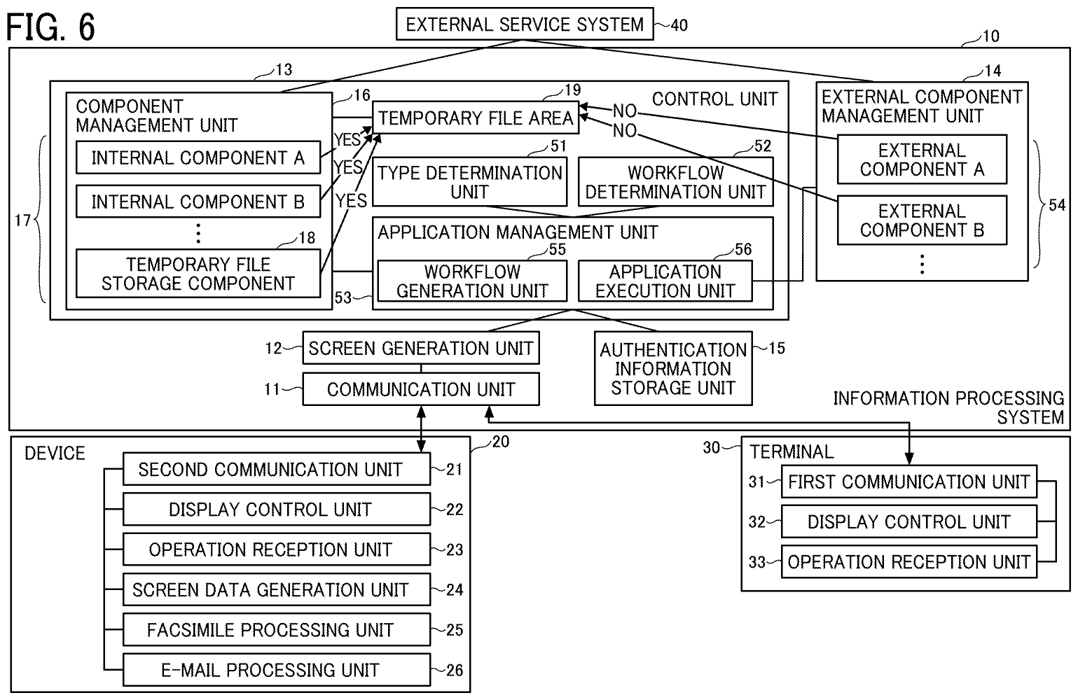

FIG. 6 is a block diagram illustrating whether the temporary file area 19 can be directly accessed from each functional unit in the functional block diagram of FIG. 5. The external component 54 that is stored and operated in the external component management unit 14 is not authorized to access the temporary file area 19. For the external component to display the preview of a file, the temporary file storage component 18, which is the internal component 17, accesses the temporary file area 19.

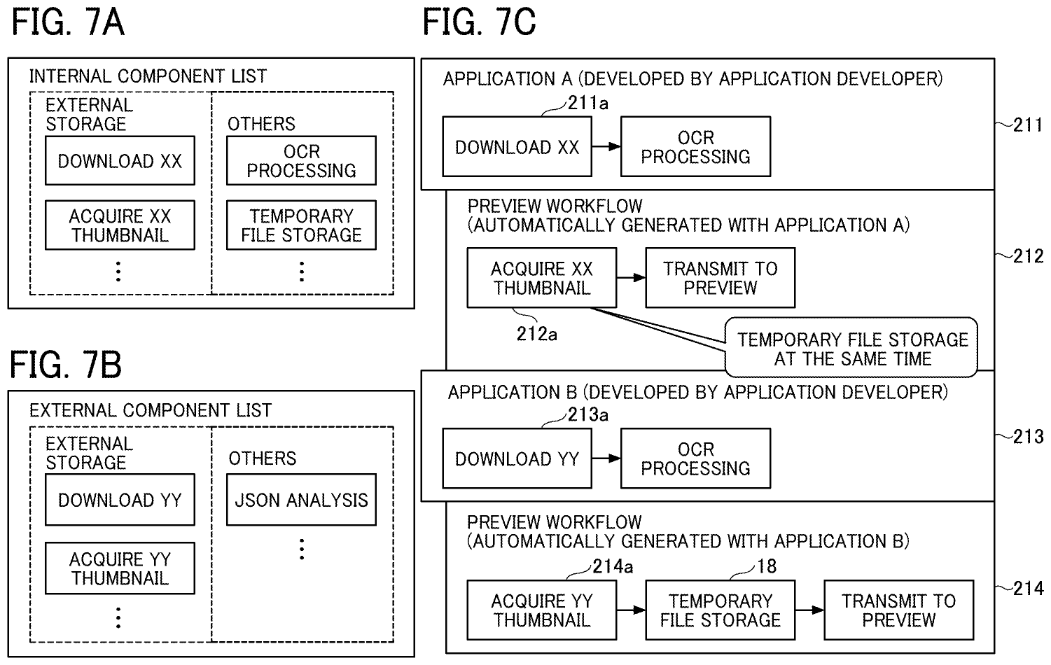

FIGS. 7A, 7B, and 7C are schematic diagrams illustrating an automatic workflow generation process executed by the workflow generation unit 55. In FIG. 7C, the automatically generated workflow is indicated as a preview workflow because the workflow displays the preview of the file.

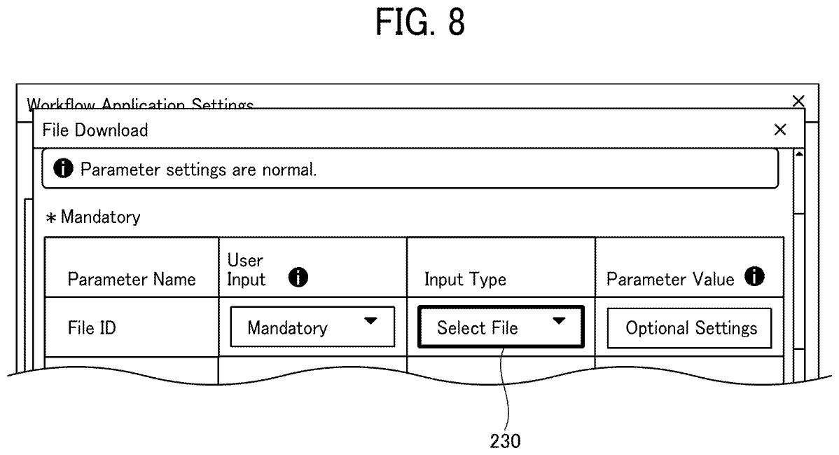

FIG. 7A illustrates an internal component list, and FIG. 7B illustrates an external component list. FIG. 8 is a diagram illustrating an example of an application creation screen.

The application developer designates a component (either internal or external) that performs “file download” from the external service system 40, select the file to download by file browse, and generates an application A 211 and an application B 213 to be used as input during execution of the application. Based on a designation of a component for “file download” (in the present embodiment, determined by the workflow determination unit 52), the workflow generation unit 55 generates a workflow to preview a file selection. The workflow generated by the workflow generation unit 55 is the automatically generated workflow and corresponds to preview workflows 212 and 214 in FIG. 7C.

In FIG. 7C, the download XX component 211a of the application A 211 is the internal component that performs “file download”. Also, the download YY component 213a of the application B 213 is the external component that performs “file download”. Accordingly, the preview workflow 212 associated with the application A 211 and the preview workflow 214 associated with the application B 213 are automatically generated.

To generate the automatically generated workflow, the type determination unit 51 determines whether the “file download” component is the internal component or the external component, and the workflow generation unit 55 changes the content of the automatically generated workflow.

In the case of the internal component, the preview workflow 212 incorporates a thumbnail acquisition component 212a prepared in advance. The thumbnail acquisition component 212a, which is the internal component, performs two processes of “acquiring a thumbnail image from the external service system” and “store in the temporary file area and acquire the URL”. Accordingly, the preview workflow 212 accompanying application A 211 does not incorporate the temporary file storage component 18.

For the external component, the thumbnail acquisition component 214a and the temporary file storage component 18 are incorporated. The thumbnail acquisition component 214a of the external component performs the process of “obtaining a thumbnail image from the external service system” and the temporary file storage component 18 performs the process of “storing in the temporary file area and obtaining the URL”.

Accordingly, the preview workflow 214 that accompanies application B 213 incorporates the temporary file storage component 18.

To allow the application developer to create an application that incorporates the temporary file storage component 18, authority to access the temporary file area 19 is to be granted. The temporary file storage component 18 is incorporated into the automatically generated workflow and is not allowed to be used by the application developers.

The application creation screen includes an input type setting field 230 as illustrated in FIG. 8. The user sets the input type (input method) of the file in the input type setting field 230. The input type setting field 230 is a pull-down menu and displays text input, selection from options, file browse, or the like in a selectable manner. In FIG. 8, “file selection” corresponds to the file browse.

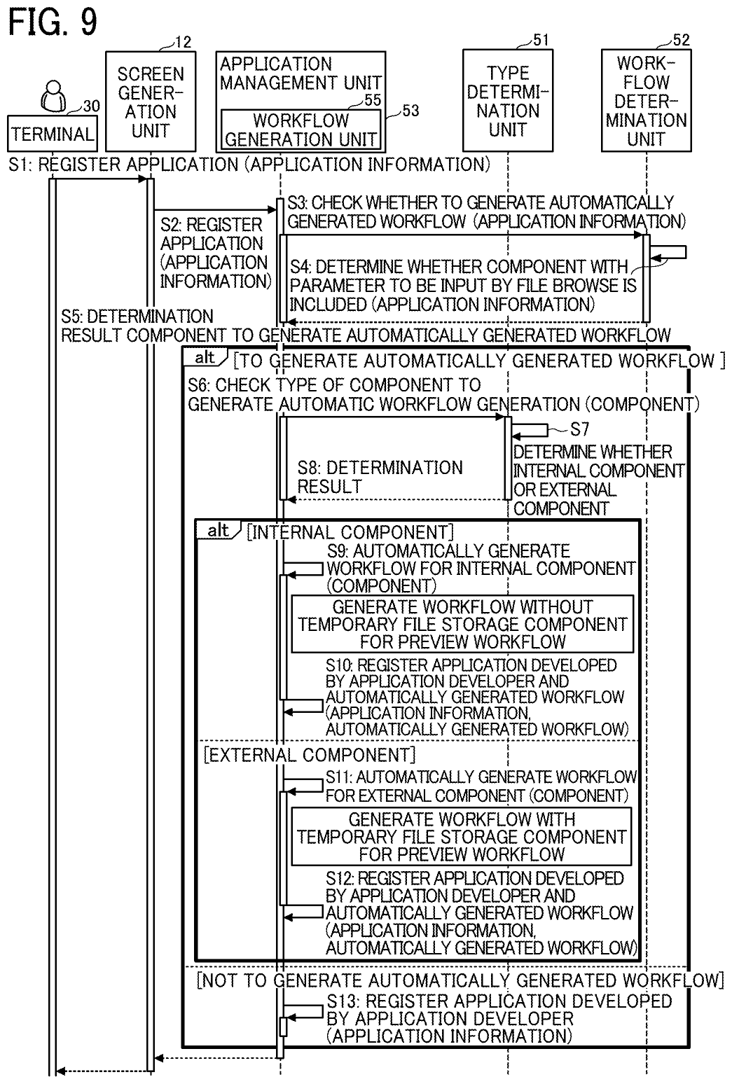

FIG. 9 is a sequence diagram illustrating an example of the automatic workflow generation process executed by the information processing system 10.

S1: The application developer operates the terminal 30 to create the application. The application is created by the application developer arranging components in order on a graphical user interface (GUI) generated by the screen generation unit 12. The operation reception unit 33 of the terminal 30 receives execution order of the components and the first communication unit 31 issues the application creation request (registration request) to the information processing system 10. The application creation request includes application information (component identification information and execution order).

Note that the component includes, as information, a parameter input method that is to be designated by the application developer. For example, the parameter input method may be text input, selection from options, file browse, or the like. The application developer designates the parameter input method to create the application. A determination of whether to generate the automatically generated workflow is to be made for the application for which the file browse is designated.

S2: The communication unit 11 of the information processing system 10 receives the application registration request and passes the request to the application management unit 53.

S3: The workflow generation unit 55 of the application management unit 53 designates application information and inquires of the workflow determination unit 52 as to whether the automatically generated workflow is to be generated.

S4: The workflow determination unit 52 determines whether the application information includes a component having parameter to be input by file browse.

S5: The workflow determination unit 52 returns to the application management unit 53 the determination result (to generate or not to generate) and the identification information of the component, based on a determination to generate the automatically generated workflow.

S6: Based on the determination to generate the automatically generated workflow, the workflow generation unit 55 designates the component to generate the automatically generated workflow and inquires the type determination unit 51 about the type (internal or external) of the component to generate the automatically generated workflow.

S7: The type determination unit 51 determines whether the component to generate the automatically generated workflow is the internal component or the external component. Examples of the determination methods are as follows.
The type determination unit 51 determines whether there is a function (process) implemented unique to the internal component.
The type determination unit 51 determines whether there is a function (process) implemented unique to the external component.
The type determination unit 51 acquires an internal component list from the component management unit 16 and determines whether the component to generate the automatically generated workflow is included.
The type determination unit 51 acquires the external component list from the external component management unit 14 and determines whether the component to generate the automatically generated workflow is included.

S8: The type determination unit 51 returns the determination result (internal component, external component) to the application management unit 53.

S9: In the case of the internal component, the workflow generation unit 55 generates an automatically generated workflow for the internal component. The automatically generated workflow for the internal component does not include the temporary file storage component 18.

S10: The workflow generation unit 55 registers the application created by the application developer and the automatically generated workflow. Specifically, the identification information and execution order of the components of the application and the automatically generated workflow are registered.

S11: In the case of the external component, the workflow generation unit 55 generates the automatically generated workflow for the external component. The automatically generated workflow for external components includes the temporary file storage component 18.

S12: The application management unit 53 registers the application created by the application developer and the automatically generated workflow. Specifically, the identification information and execution order of the components of the application and the automatically generated workflow are registered.

S13: Based on a determination not to generate the automatically generated workflow, the application management unit 53 registers the application created by the application developer. Specifically, the identification information and execution order of the components included in the application are registered.

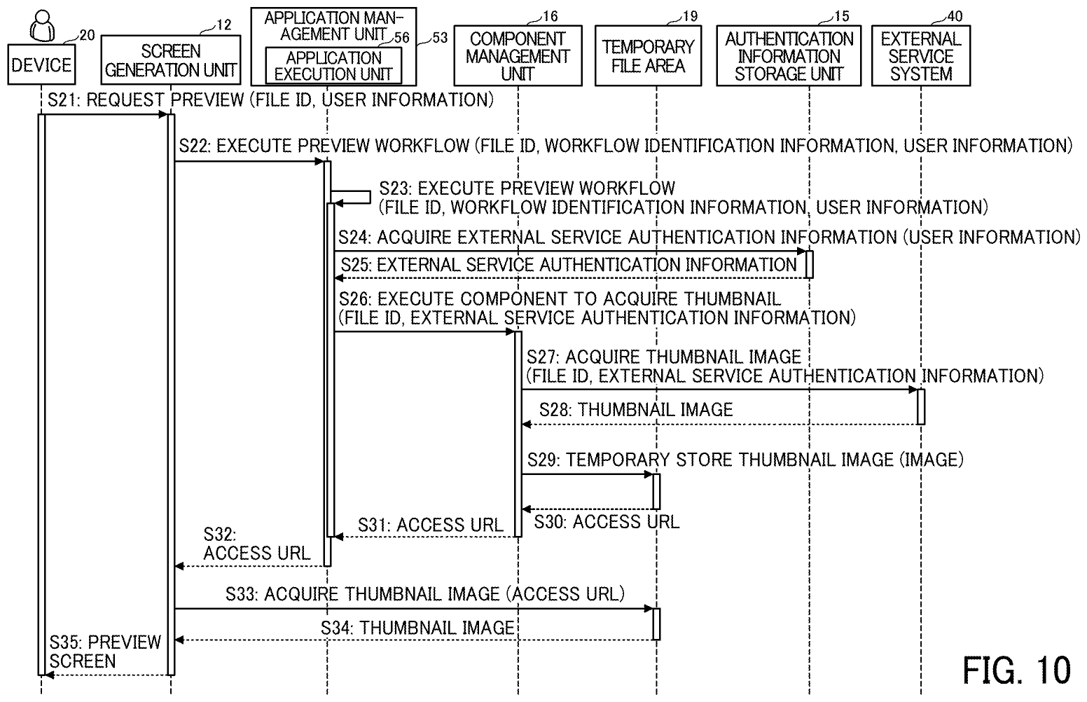

With reference to FIG. 10, an execution of the application including the internal component is described. Note that when the application is executed, whether the component is the internal component or the external component is not particularly determined. The application execution unit 56 sequentially executes the components included in the automatically generated workflow associated with the application.

FIG. 10 is a sequence diagram illustrating an example of a display process of the preview of a file executed by the application including the internal component.

S21: The user executes the application that selects a file to be downloaded by file browse and uses the file as an input for the application on the device 20. The user selects the file with this application. The operation reception unit 23 of the device 20 receives the selection of the file and the second communication unit 21 designates the file ID (file identification information) and user information and requests the information processing system for the preview. The user information may be a user ID used to log into the device 20, or may be temporary identification information such as a token.

S22: The communication unit 11 of the information processing system 10 receives the preview request, and the screen generation unit 12 designates the file ID, preview workflow identification information, and user information, and instructs the application execution unit 56 to execute the preview workflow. The preview workflow is associated with the application for file browse, and the identification information of the preview workflow is also sent to the application execution unit 56.

S23: The application execution unit 56 starts executing the preview workflow.

S24, S25: The application execution unit 56 designates user information and acquires the authentication information of the user in the external service system 40 from the authentication information storage unit 15.

S26: The application execution unit 56 designates the file ID and the authentication information of the external service system 40, and requests the component management unit 16 to execute the thumbnail acquisition component 212a included in the preview workflow.

S27, S28: The component management unit 16 calls and executes the thumbnail acquisition component 212a. The thumbnail acquisition component 212a acquires the thumbnail image of the file identified by the file ID from the external service system 40 by designating the file ID and authentication information of the external service system.

S29, S30: The thumbnail acquisition component 212a stores the thumbnail image in the temporary file area 19 and acquires the URL of the storage destination.

S31: The component management unit 16 returns the URL to the application execution unit 56.

S32: The application execution unit 56 transmits the URL to the screen generation unit 12.

S33, S34: The screen generation unit 12 acquires the thumbnail image identified by the URL of the temporary file area 19 from the temporary file area 19.

S35: The screen generation unit 12 generates screen information for displaying thumbnail images and transmits the information to the device 20 through the communication unit 11. The second communication unit 21 of the device 20 receives the screen information, and the display control unit 22 displays thumbnail image (file preview image). An example of the preview image is illustrated in FIG. 15.

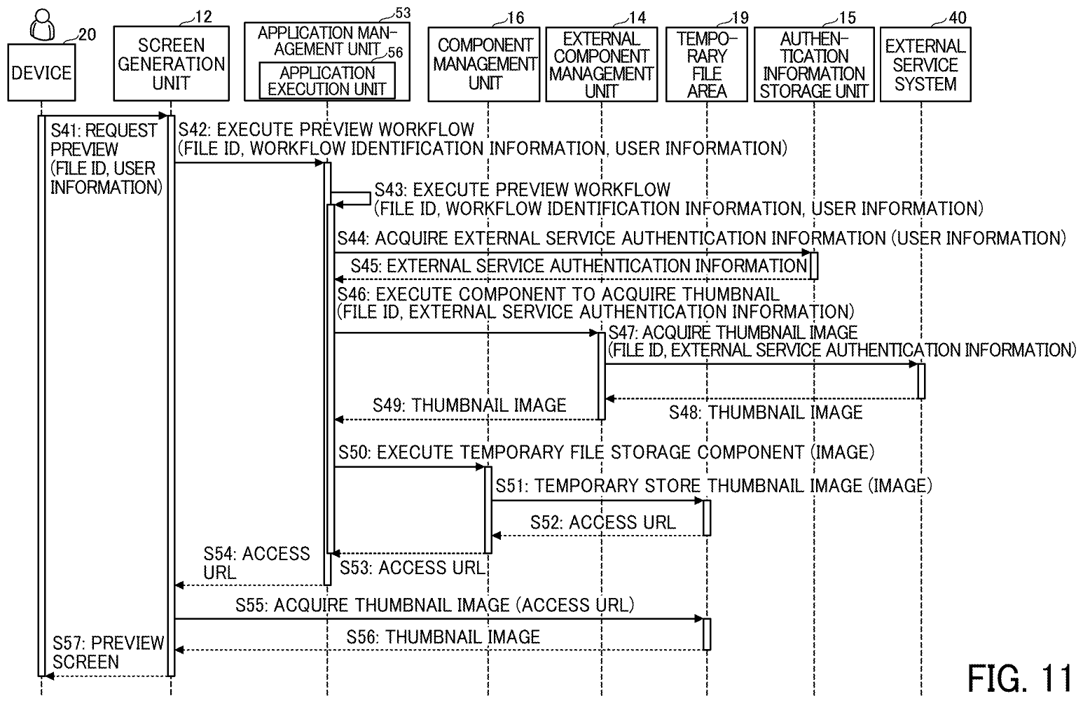

With reference to FIG. 11, an execution of the application including the internal component is described. FIG. 11 is a sequence diagram illustrating an example of a display process of the preview of a file executed by the application including the external component. In the description of FIG. 11, the difference from FIG. 10 is mainly described. The processing of steps S41 to S45 may be the same as steps S21 to S25 of FIG. 10.

S46: The application execution unit 56 designates the file ID and the authentication information of the external service system 40, and requests the external component management unit 14 to execute the thumbnail acquisition component 214a included in the automatically generated workflow. The application execution unit 56 switches the component request destination to the component management unit 16 or the external component management unit 14 according to the identification information of the component.

S47, S48: The external component management unit 14 calls and executes the thumbnail acquisition component 214a. The thumbnail acquisition component 214a acquires the thumbnail image of the file identified by the file ID from the external service system 40 by designating the file ID and authentication information of the external service system 40.

S49: The thumbnail acquisition component 214a returns the thumbnail image to the application execution unit 56.

S50: The application execution unit 56 designates the thumbnail image and requests the component management unit 16 to execute the temporary file storage component 18 included in the preview workflow.

S51, S52: The component management unit 16 calls and executes the temporary file storage component 18. The temporary file storage component 18 stores the thumbnail image in the temporary file area 19 and acquires the URL of the storage destination.

S53: The temporary file storage component 18 returns the URL to the application execution unit 56.

Subsequent steps S54 to S57 may be the same as steps S32 to S35 in FIG. 10.

According to the present embodiment, the preview of a file is displayed in the workflow including the external component.

As described above, in the present embodiment, the component (temporary file storage component 18) for saving thumbnail images in the temporary file area 19 is prepared, and for the application that displays preview using the external component, the information processing system 10 automatically generates the automatically generated workflow including the temporary file storage component 18. The temporary file storage component 18 is executed in the case the external component displays the preview.

By doing so, the external component implements the preview function without removing the restriction that the thumbnail image is not stored in the temporary file area 19 from the external component.

In a second embodiment, a description is given of the information processing system 10 that generates the automatically generated workflow that incorporates the temporary file storage component 18 regardless of whether the component is the internal component or the external component.

In the second embodiment, the hardware configurations illustrated in FIGS. 3 and 4 and the functional configuration illustrated in FIG. 5 described in the above embodiment are applicable. However, in the present embodiment, the type determination unit 51 is not included.

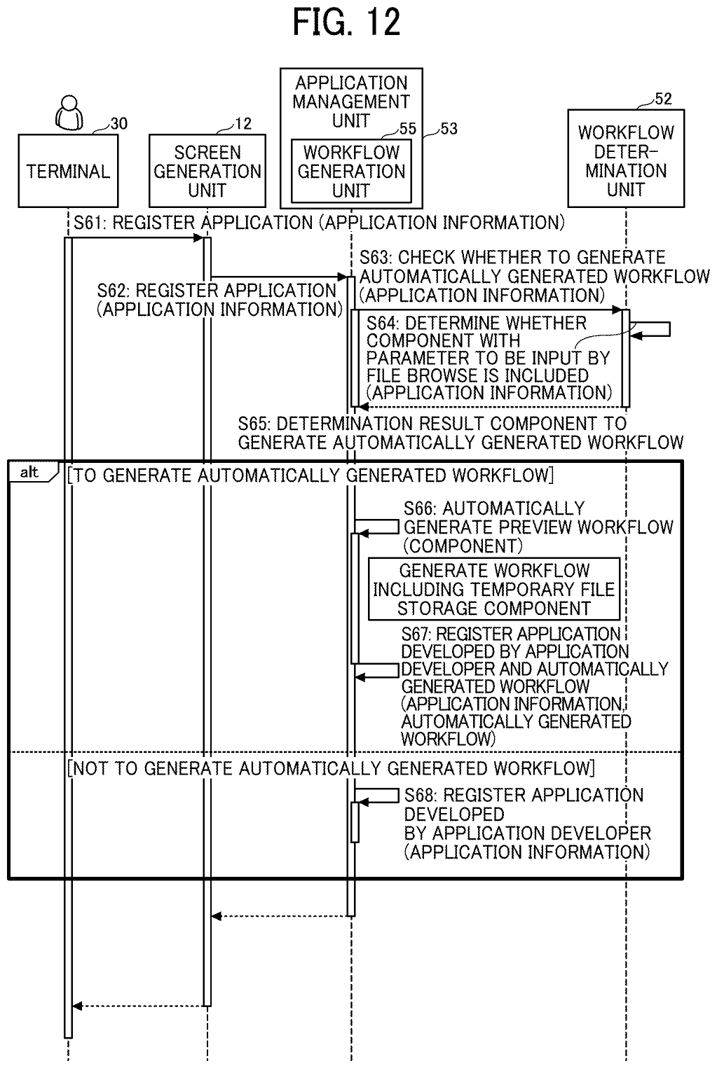

FIG. 12 is a sequence diagram illustrating an example of the automatic workflow generation process executed by the information processing system. In the description of FIG. 12, difference from FIG. 9 is mainly described. The processing of steps S61 to S65 of FIG. 12 may be the same as the processing of steps S1 to S5 of FIG. 9. However, in FIG. 12, the type determination unit 51 does not determine whether a component to generate the automatically generated workflow is the internal component or the external component.

S66: Based on a determination to generate the automatically generated workflow, the workflow generation unit 55 generates the automatically generated workflow common to internal and external components (regardless of whether the component is the internal component or the external component). This automatically generated workflow includes the temporary file storage component 18.

S67: The workflow generation unit 55 registers the application created by the application developer and the automatically generated workflow. Specifically, the identification information and execution order of the components of the application and the automatically generated workflow are registered.

S68: Based on a determination not to generate the automatically generated workflow, the workflow generation unit 55 registers the application created by the application developer. Specifically, the identification information and execution order of the components included in the application are registered.

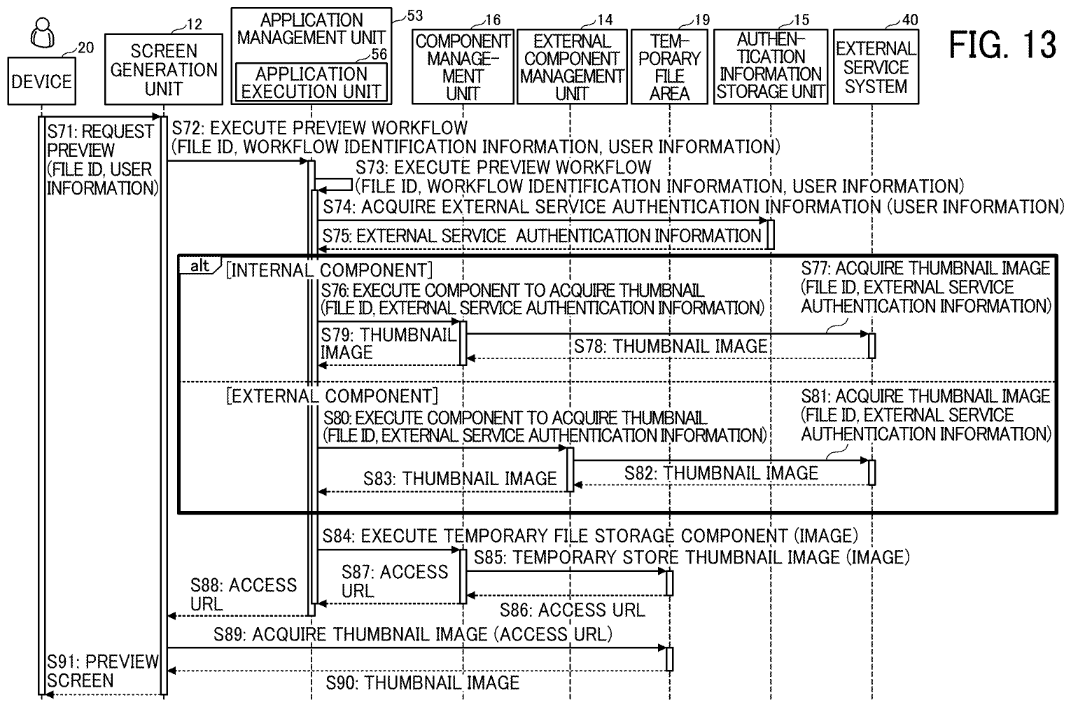

FIG. 13 is a sequence diagram illustrating an example of a display process of the preview of a file executed by the application for which the automatically generated workflow has been generated. In the description of FIG. 13, differences from FIG. 10 is mainly described. The processing of steps S71 to S75 of FIG. 13 may be the same as the processing of steps S21 to S25 of FIG. 10.

S76: In the case of the internal component, the application execution unit 56 designates the file ID and authentication information of the external service system 40 and requests the component management unit 16 to execute the thumbnail acquisition component 212a included in the preview workflow.

S77, S78: The component management unit 16 calls and executes the thumbnail acquisition component 212a. The thumbnail acquisition component 212a does not perform temporary file storage. The thumbnail acquisition component 212a acquires the thumbnail image of the file identified by the file ID from the external service system 40 by designating the file ID and authentication information of the external service system.

S79: The thumbnail acquisition component 212a returns the thumbnail image to the application execution unit 56.

S80: In the case of the internal component, the application execution unit 56 designates the file ID and authentication information of the external service system 40 and requests the external component management unit 14 to execute the thumbnail acquisition component 214a included in the preview workflow.

S81, S82: The external component management unit 14 calls and executes the thumbnail acquisition component 214a. The thumbnail acquisition component 214a acquires the thumbnail image of the file identified by the file ID from the external service system 40 by designating the file ID and authentication information of the external service system 40.

S83: The thumbnail acquisition component 214a returns the thumbnail image to the application execution unit 56.

S84: Regardless of whether the component is the internal component or the external component, the application execution unit 56 designates the thumbnail image and requests the component management unit 16 to execute the temporary file storage component 18.

S85, S86: The component management unit 16 calls and executes the temporary file storage component 18. The temporary file storage component 18 stores the thumbnail image in the temporary file area 19 and acquires the URL of the storage destination.

S87: The component management unit 16 returns the URL to the application execution unit 56.

Subsequent steps S88 to S91 may be the same as steps S32 to S35 in FIG. 10.

In the present embodiment, a common automatically generated workflow is generated without determining whether the component to generate the automatically generated workflow is the internal component or the external component. The automatically generated workflow that uses the temporary file storage component 18 does not perform temporary file storage in thumbnail acquisition component 212a (and also 214a) corresponding to the external service system 40. Accordingly, by using the temporary file storage component 18 in the internal component as well as in the external component, implementation work in creating the thumbnail acquisition component may be reduced.

In the second embodiment, the workflow generation unit 55 generated the automatically generated workflow that uses the temporary file storage component 18 for the internal component as well. However, depending on processing power of the information processing system 10, etc., a configuration in which the temporary file storage component 18 is not used for the internal component may be desirable. For example, an increase in processing time due to an increase in the number of accesses from the application management unit 53 to the component management unit 16 may be anticipated.

In the third embodiment, an information processing system 10 which selects whether to incorporate the temporary file storage component 18 into the automatically generated workflow for each internal component is described. In the third embodiment, for the internal component that uses the external service system 40, the application developer selects and implements one of the following when implementing the thumbnail acquisition component.
a. Implement both processes of “obtain thumbnail image from external service system” and “store in temporary file area 19 and obtain URL for access.”
b. Implement just the process of “obtain thumbnail image from external service system.”

The type determination unit 51 determines whether process a or process b is implemented in the internal component (which process exists), and based on the determination, the workflow generation unit 55 determines whether to incorporate the temporary file storage component 18 into the automatically generated workflow.

In the third embodiment, the hardware configurations illustrated in FIGS. 3 and 4 and the functional configuration illustrated in FIG. 5 described in the above embodiment are applicable.

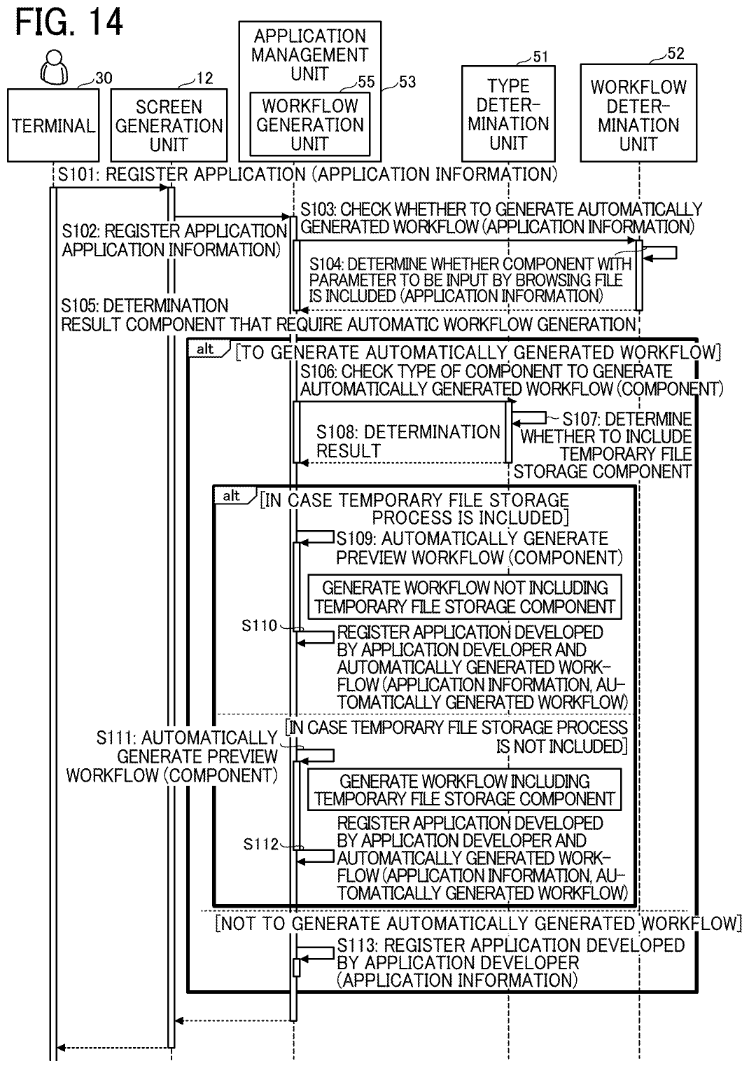

FIG. 14 is a sequence diagram illustrating an example of the automatic workflow generation process executed by the information processing system 10. In the description of FIG. 14, difference from FIG. 12 is mainly described. The processing of steps S101 to S105 of FIG. 14 may be the same as the processing of steps S61 to S65 of FIG. 12.

S106: Based on a determination to generate the automatically generated workflow, the workflow generation unit 55 designates the component and inquires of the type determination unit 51 about the type of component to generate the automatically generated workflow.

S107: The type determination unit 51 determines whether the component to generate the automatically generated workflow is the component that incorporates the temporary file storage component 18. Examples of the determination methods are as follows.
a. Implement both processes of “obtain thumbnail image from external service system” and “store in temporary file area 19 and obtain URL for access,” and do not incorporate the temporary file storage component 18.
b. Implement just the process of “obtain thumbnail image from the external service system,” and incorporate the temporary file storage component 18

S108: The type determination unit 51 returns the determination result (whether to store temporary file) to the application management unit 53.

S109: In the case the component to generate the automatically generated workflow includes the temporary file storage process, the workflow generation unit 55 generates the automatically generated workflow that does not include the temporary file storage component 18. Since a part of the internal component implements the process of “storing in the temporary file area 19 and acquiring the URL for access”, the workflow generation unit 55 generates an automatically generated workflow that does not include the temporary file storage component 18.

S110: The workflow generation unit 55 registers the application created by the application developer and the automatically generated workflow. Specifically, the identification information and execution order of the components of the application and the automatically generated workflow are registered.

S111: In the case the component to generate the automatically generated workflow does not include the temporary file storage process, the workflow generation unit 55 generates the automatically generated workflow including the temporary file storage component 18. Since a part of the internal component does not implement the process of “storing in the temporary file area 19 and acquiring the URL for access”, the workflow generation unit 55 generates the automatically generated workflow that includes the temporary file storage component 18. In addition, since none of the external component implements the process of “storing in the temporary file area 19 and acquiring the URL for access”, for all of the external components, the workflow generation unit 55 generates the automatically generated workflows that include the temporary file storage component 18.

S112: The workflow generation unit 55 registers the application created by the application developer and the automatically generated workflow. Specifically, the identification information and execution order of the components of the application and the automatically generated workflow are registered.

S113: Based on the determination not to generate the automatically generated workflow, the workflow generation unit 55 registers the application created by the application developer. Specifically, the identification information and execution order of the components included in the application are registered.

The execution process of the automatically generated workflow thus generated is the same as in FIGS. 10 and 11 of the first embodiment. FIG. 10 is executed when the automatically generated workflow including the temporary file storage component 18 is executed, and FIG. 11 is executed when the automatically generated workflow which does not include the temporary file storage component 18 is executed.

According to the present embodiment, the information processing system 10 controls whether to incorporate the temporary file storage component 18 with respect to the internal component. For example, an increase in processing time due to an increase in the number of accesses from the application execution unit 56 to the component management unit 16 may be reduced.

In the fourth embodiment, a description is given of the information processing system 10 that generates the automatically generated workflow including the temporary file storage component 18 for purposes other than the display of preview.

As illustrated in FIG. 15, the temporary file storage component 18 may be used for the following purposes in addition to the display of preview. FIG. 15 is a diagram illustrating an example of a file browse screen displayed by the device 20. FIG. 16 is a diagram illustrating a display example of a preview image of a file selected by file browse. A preview button 221 is displayed on the file browse screen in association with each file. In response to the pressing of the preview button 221 by the user, the device 20 displays a preview (thumbnail) 223 of the file.

Also, the file browse screen illustrated in FIG. 15 displays an icon 220 at the top of the file name. The external component acquires the icon 220 from the external service system 40, stores the icon 220 in the temporary file area 19, and uses the icon 220.

The file browse screen uses images prepared by the system (operating system (OS), etc.) of the device 20 to display icons of folders and files. The temporary file storage component 18 changes the icon to a unique icon held by the external service system 40. To enable a display of the icon 220 unique to the external service system 40, the workflow generation unit 55 incorporates the temporary file storage component 18 into the automatically generated workflow similarly to the preview function.

The application execution unit 56 executes the automatically generated workflow as follows.

The external component acquires icon image from external service system 40, the temporary file storage component 18 stores the icon image in the temporary file area 19 and issues a URL, and the screen generation unit 12 embeds the icon image in the file browse screen.

According to the present embodiment, the temporary file storage component 18 allows the device 20 to display images obtained from the external service system 40 as icons.

The above-described embodiment is illustrative and do not limit the present disclosure. Thus, numerous additional modifications and variations are possible in light of the above teachings within the scope of the present disclosure. Any one of the above-described operations may be performed in various other ways, for example, in an order different from the one described above.

For example, the configuration example in FIG. 5 and the like are divided according to main functions in order to facilitate understanding of processing by the terminal 30, the device 20, and the information processing system 10. The present disclosure is not limited by the way of dividing the processing unit or the name. The processing of the terminal 30, the device 20, and the information processing system 10 may be divided into more processing units according to the content of the processing. Further, one process may be divided to include a larger number of processes.

The apparatuses or devices described in one or more embodiments are just one example of plural computing environments that implement the one or more embodiments disclosed herein. In some embodiments, information processing system 10 includes multiple computing devices, such as a server cluster. The plurality of computing devices is configured to communicate with one another through any type of communication link, including a network, shared memory, etc., and perform the processes disclosed herein.

Further, the information processing system 10 may be configured to share the processing steps disclosed in the present embodiment, for example, FIGS. 9 to 14 and the like in various combinations. For example, a process executed by a given unit may be executed by a plurality of information processing apparatuses included in the information processing system 10. Further, the information processing system 10 may be integrated into one server or may be divided into a plurality of devices.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

1. An information processing system comprising:
circuitry configured to:
receive a request to create an application that includes one or more processes;
generate a workflow in which a process of storing data in a storage area is added to a process of acquiring the data from outside based on the one or more processes included in the application;
execute the application and the workflow in response to receiving a request for executing the application from a device; and
provide the device with screen information for displaying information on the data stored in the storage area.

2. The information processing system of claim 1, wherein the circuitry is further configured to determine whether to generate the workflow depending on whether the one or more processes included in the application includes a process related to file browse.

3. The information processing system of claim 2, wherein in a case where the circuity determines to generate the workflow, the circuitry is further configured to generate the workflow according to a type of the process included in the application that is related to whether the process is allowed to store the data in the storage area.

4. The information processing system of claim 3, wherein the circuitry is further configured to:
in a case the process included in the application is of a first type that is allowed to store data in the storage area, generate a workflow for acquiring data from outside and storing the data in the storage area by the process of the first type; and
in a case the process included in the application is of a second type that is not allowed to store data in the storage area, generate a workflow in which process of the first type for storing the data in the storage area is added to the process for acquiring the data from the outside by the process of the second type.

5. The information processing system of claim 1, wherein the circuitry is configured to generate a workflow in which the process of a first type for storing the data in the storage area is added to the process of a second type for acquiring the data from the outside.

6. The information processing system of claim 4, wherein the process of the first type issues a URL of the data in the storage area, in a case of generating a workflow in which the process of the first type for storing the data in the storage area is added to the process of the second type for acquiring the data from the outside, and
the circuitry is further configured to generate the screen information for displaying the information on the data stored in the storage area identified by the URL.

7. The information processing system of claim 3, wherein the circuitry is further configured to:
determine whether the process included in the application includes a function of storing the data in the storage area;
based on a determination that the process included in the application includes the function of storing the data in the storage area, generate a workflow for acquiring the data from the outside and storing the data in the storage area by the process of the first type including the function of storing the data in the storage area; and
based on a determination that the process included in the application does not include the function of storing the data in the storage area, generate a workflow in which the process of the first type for storing the data in the storage area is added to the process of the second type for acquiring the data from the outside, the process of the second type not including the function of storing the data in the storage area.

8. The information processing system of claim 1, wherein the application transmits to the device, a list of files obtained from the outside, and the workflow stores a thumbnail of at least one of the files designated by the device as the data in the storage area, and
the circuitry is configured to provide the device with the screen information for displaying the thumbnail of the file stored in the storage area.

9. The information processing system of claim 1, wherein the application transmits to the device, a list of files obtained from the outside, and the workflow stores an icon of at least one of the files designated by the device as the data in the storage area, and
the circuitry is configured to provide the device with the screen information for displaying the icon of the file stored in the storage area.

10. A service providing system comprising:
an information processing system of claim 1; and
a device communicably connected with the information processing system,
the device including circuitry configured to display on a display, data based on the screen information received from the information processing system.

11. A service providing system comprising:
circuitry configured to:
in response to receiving a request to create an application that includes one or more processes, generate a workflow in which a process of storing data in a storage area is added to a process of acquiring the data from outside based on the one or more processes included in the application;
execute the application and the workflow in response to receiving a request for executing the application; and
display, on a display, data based on screen information including information on the data stored in the storage area.

12. An application execution method comprising:
receiving a request to create an application that includes one or more processes;
generating a workflow in which a process of storing data in a storage area is added to a process of acquiring data from outside based on the one or more processes included in the application;
executing the application and the workflow in response to receiving a request for executing the application from a device; and
providing the device with screen information for displaying information on the data stored in the storage area.
